(19) United States
(12) Patent Application Publication
(10) Pub. No.: US 2021/0268685 A1
(43) Pub. Date: Sep. 2, 2021

(54) METHOD AND DEVICE FOR PRODUCING A COMPOSITE WOOD BOARD

(71) Applicant: SWISS KRONO Tec AG, Luzern (CH)

(72) Inventors: Norbert KALWA, Horn-Bad Meinberg (DE); Torsten KOPP, Marnitz (DE)

(21) Appl. No.: 16/640,848

(22) PCT Filed: Sep. 17, 2018
(86) PCT No.: PCT/EP2018/075027

§ 371 Date: Feb. 21, 2020

(30) Foreign Application Priority Data
Oct. 16, 2017 (EP) 17196573.4

(51) Int. Cl. B27N 1/02; B27N 1/00; B27N 3/00; B27N 3/02; B27N 3/18; B27N 9/00

(52) U.S. Cl. CPC B27N 1/029; B27N 1/006; B27N 9/00; B27N 3/02; B27N 3/18; B27N 3/005

(57) ABSTRACT

The method relates to a method for producing a wood material panel. The method includes the following steps: (a) scattering a multitude of wood particles to produce a particulate cake, (b) applying an adhesive to at least some of the wood particles during the scattering and/or prior to the scattering, and (c) pressing of the particulate cake under high pressure and at a high temperature, wherein a quantity of adhesive that is applied to the wood particles is varied depending on its anticipated position in the particulate cake.

### FIELD OF INVENTION

The method relates to a method for producing a wood material panel, wherein the method comprises the following steps: (a) scattering a multitude of wood particles to form a particulate cake, (b) applying adhesive to at least some of the wood particles during the scattering and/or prior to the scattering, (c) pressing the particulate cake under high pressure and at a high temperature. The invention also relates to a device for conducting such a method.

### BACKGROUND

Wood material panels are used in a broad range of technical industries. For instance, they are used for wooden floors, wall coverings, furniture or in wood construction work.

Wood materials and specifically wood material panels have a core made of wood particles and, generally speaking, some adhesive. With regards to the wood particles, wood strands, wood chips and wood fibers in particular are used. They are generally pressed in a continuous or interval-based method to form panels or at least to produce the core, wherein such a method is conducted under the influence of heat and pressure: this is so-called hot pressing.

Due to the diverse range of their possible uses, wood material panels have to withstand and fulfill many different loads and demands. This includes, for example, loads applied at specific points or across a surface, for instance if the panels are used as furniture panels, doors or flooring elements.

Wood material panels are normally produced in such a way that their properties are uniform and as consistent as possible across the entire expanse of a panel, wherein such properties may be, for example bulk density or resistance against impact loads or deflections.

The bulk density is the ratio of mass to volume in the wood material panel and is, amongst other things, a parameter for the resistance of a wood material panel.

Generally, the higher the bulk density, the greater the resistance of a wood material panel. For example, current wood material panels have a bulk density of 620 kg/m³ to 650 kg/m³ in chipboard panels, 600 kg/m³ to 650 kg/m³ in OSB and 700 kg/m³ in MDF.

Depending on their intended use, wood material panels have to withstand a very broad range of loads. For example, if used as a furniture panel or door panel, these loads are not constant across the entire surface of the wood material panel. A door panel has to withstand considerably higher loads around the hinges than across the rest of the door panel. The same applies for cupboard doors or shelves: here, very high loads are anticipated in the region surrounding the small contact surfaces.

If the use and in particular the orientation of the wood material panel are known, the bulk density can be designed to be lower in the areas subjected to smaller loads, meaning that the panel weight is lower and material can be saved. Such a method is known from EP 2 653 279 A1: here, particles are removed from a falling particulate curtain. WO 2005/046950 A1 also describes a method and a corresponding device which, when used, allow for fewer particles to be used in certain areas of the wood material panel so as to reduce the bulk density in these areas. However, there are restrictions regarding the reduction in the particles spread in an area, as the amount of particles must be sufficient to prevent the occurrence of indentations or dents in the wood material panel to be produced.

The individual adjustment of certain properties of wood material panels is also known from EP 2 623 282 A1, which describes a method for impregnating material panels that comprises the introduction of an impregnation agent into a previously pressed wood material panel. This ensures that peripheral areas are impregnated and that no impregnation agent is used in the middle layers.

### SUMMARY

The present invention aims to provide a method for producing a wood material panel that has a different bulk density in different areas, wherein the method is as simple as possible and further reduces production costs.

The invention solves the problem by way of a method according to the generic term in claim 1, which is characterized in that a quantity of adhesive that is applied to the wood particles varies depending on the anticipated position of said particles in the particulate cake.

On the one hand, this enables a reduction in the amount of adhesive used, which reduces, for instance, the emission of volatile adhesive components; on the other hand, the bulk density in these areas can be further reduced without having to reduce the quantity of particles scattered. The applied quantity of adhesive varies depending on the anticipated position of the particle that is to be glued. Hence, it may vary across the thickness of the wood material panel and/or in a plane parallel to the surface of the wood material panel.

Preferably, an adhesive is not applied to the wood particles until the scattering phase. The particles leave a scattering device or a conveyor and are glued as they fall; this is achieved by spraying the adhesive onto the falling particles through at least one glue nozzle. The quantity of adhesive applied is varied depending on the anticipated position within the particulate cake. As a result, the quantity of adhesive dispensed by the at least one glue nozzle during the process that produces such a particulate cake also varies. This may also be achieved by changing the output quantity of at least one nozzle and/or by changing the number of spraying nozzles.

It is particularly preferable if several, in particular all, wood particles are pre-glued with a preferably constant amount of adhesive prior to scattering. The wood particles that are pre-glued in this manner are then scattered to form a particulate cake. During the scattering of the pre-glued wood particles, additional adhesive is then applied in varying quantities to all or only some wood particles. To this end, the already pre-glued and/or unglued wood particles are guided in an air stream past the at least one glue nozzle, for instance, which applies different quantities of adhesive under program control.

In particular, the adhesives used are urea formaldehyde resins, melamine resins or phenolic resins. Preferably, they are isocyanates, such as polymeric diphenylmethane diisocyanate (PMDI), which is specifically free of formaldehyde.

Preferably, the method features an introduction of one or several additives into the particulate cake during the scattering process. Specifically, the addition of additives renders it possible to influence further properties of the wood material panel. Such additives include, in particular, fire-retardant substances, biocidal substances, substances for preventing the swelling of wood, substances that influence the visual and/or haptic impression of the eventual wood material panel, substances that alter thermal conductivity or electrical conductivity, such as foamers and pre-foamed substances.

The at least on additive preferably contains at least one filler, such as chalk, talcum, quartz powder, glass beads, expanded glass or expanded clay; at least one optical brightener, such as titanium dioxide, calcium carbonate or fluorescent organic substances; at least one fire-retardant substance, at least one biocidal substance, at least one substance for preventing the swelling of wood, at least one foamer and/or at least one substance that alters a visual and/or haptic and/or physical property of the wood material panel, such as its thermal conductivity.

Moreover, the additives may be primers, for instance based on silanes or other bonding agents. In particular, these improve the adhesion of different glue systems or different layers to one another. Furthermore, it is also possible to apply substances that form an intermediate layer, thereby preventing individual different layers from mixing. For example, in the case of chipboard panels, it is thus possible to prevent particles of relatively thin top layers from migrating into a coarser middle layer, or to make it more difficult for them to do so.

In addition or in lieu of the introduction of additives, energy in the form of, for instance, heat or radiation can be introduced. This renders it possible, for example, to specifically trigger or influence adhesive reactions of multi-component adhesives or reactions caused by or with additives. It is also possible to introduce moisture into the particulate cake, for example by treating with steam.

It is preferable if different quantities of additives are introduced at different positions within the particulate cake. In this way, the influenced properties can be formed in different areas or formed or varied to different degrees. Different additives and/or different quantities of different additives are preferably introduced at different positions within the particulate cake.

In particular, the one additive or the several additives are introduced by separate introduction devices, such as nozzles. Specifically, this can be conducted not only during the scattering process, but also when no wood particles are being scattered.

The at least one additive is preferably another adhesive or an adhesive component. Within the scope of the present invention, the application of adhesive should also be understood to mean, for example, the application of one or several adhesive components, wherein this may occur in varying amounts or further adhesive components are applied in varying amounts.

Preferably, a quantity of wood particles, which are scattered to form a particulate cake, varies depending on their anticipated position in the particulate cake. As a result, it is particularly possible—by selecting different quantities of scattered wood particles—to further influence the bulk density within the particulate cake and therefore also the resistance.

The invention also solves the problem by way of a device for conducting a method described here, which comprises an electrical control system that is configured to vary a quantity of adhesive that is to be applied to the wood particles depending on their anticipated position in the particulate cake.

The electrical control system preferably has an electronic data processing device that is configured to access information saved in an electronic memory and, based on this information, to vary the quantity of adhesive to be applied. This can be done by controlling an amount of adhesive supplied to at least one nozzle and/or by opening and closing nozzles.

The device preferably has at least one glue nozzle; it is especially preferable if it has several glue nozzles. The at least one glue nozzle is preferably designed to be movable; in particular, it can be moved transversely to a transport direction of a conveyor belt, onto which the wood particles are scattered.

In an especially preferred embodiment, the anticipated position of the wood particles is or can be determined using a position of the scattering nozzle that scatters the wood particles. This can be achieved regardless of whether such a scattering nozzle is configured to be movable or immovable relative to the particulate cake. The question of whether the wood particles are applied prior to scattering or during the scattering of the adhesive preferably depends on the type of adhesive. For example, in the case of adhesives with a particularly low drop time, it is practical for application to occur during the scattering process.

It is also possible for the anticipated position of the wood particles in the particulate cake to be determined or calculated during the scattering process. To this end, a measurement installation may be arranged on the device, for example. This may be, for instance, a high-speed camera or similar. In this case, it is practical for the adhesive to be applied during scattering.

The device preferably has a conveyor belt, which can be moved in a transport direction, wherein the at least one scattering nozzle is arranged above the conveyor belt and is configured to scatter the wood particles on the conveyor belt. The particular advantage of such a conveyor belt is that the wood material panels or the particulate cake can be produced continuously. However, a conveyor belt also renders it possible to produce the wood material panels on a cyclical basis, for example.

The anticipated position of the wood particles in the particulate cake is preferably calculated using the position of the corresponding scattering nozzle that scatters the wood particles, especially in relation to the particulate cake to be scattered. This preferably takes into account a transport speed of the conveyor belt.

It is preferable if the at least one glue nozzle is arranged above the conveyor belt and configured to apply adhesive to the wood particles during the scattering process. In this case, preferably one, but in particular several, of the glue nozzles is/are arranged in a glue scattering head, such that this glue scattering head can be moved—in particular in its entirety—without effecting a change in an orientation or position of the glue nozzles and the scattering nozzles.

Several scattering nozzles and/or several glue nozzles are preferably arranged transversely to the transport direction. Specifically, they are arranged across the entire width of the particulate cake or across the entire width of the conveyor belt. This is practical because it means that wood particles and/or adhesive can be applied in particular at variable intervals.

Preferably, several glue nozzles form a glue strip. It is also possible that two such glue strips are combined to form a glue head. Furthermore, it is preferable if at least one glue strip is combined with at least one scattering nozzle, especially at least one scattering strip consisting of several scattering nozzles, to form a scattering-glue head, of which the device preferably has several.

In particular, if movable glue nozzles are used, existing devices can be retrofitted and benefit from the advantages of the present invention. Furthermore, as a result of this movability, it is possible to adjust the production device to allow for different sized wood material panels to be produced without it requiring too much effort.

The electrical control system is preferably configured to vary the amount of wood particles depending on their anticipated position in the particulate cake.

According to an example of an embodiment of the present invention for producing a 19 mm chipboard panel, urea formaldehyde glue is used as an adhesive. To this end, air scattering is first used to scatter a lower cover layer of wood particles onto a conveyor belt. A thin layer of foamed urea formaldehyde glue (20 g fl/m², solids content approximately 50%) is then applied by a row of glue nozzles. A middle layer is then applied using throw scattering. An identical amount of foamed resin is then also applied to this layer using glue nozzles. Air scattering is then used to apply an upper cover layer. The ratio of cover layer to middle layer is approximately 28 to 72%. The resulting particulate cake in the form of a chip cake is pressed in a Contipress to form a chipboard panel, which is then cooled and polished.

Within the scope of a test, a chipboard panel was produced without the intermediate adhesive layers. Both panels were subsequently covered with a white decorative paper in a high-speed press, wherein said decorative paper was impregnated with a melamine resin. The weight of the paper was 65 g/m². The cross-sections of panels were then visually inspected.

It was evident that the chipboard panel with the adhesive exhibited a considerably more symmetrical structure between the layers. Considerably less cover layer migration into the middle layer was observed, specifically between the upper cover layer and the middle layer, than was observed in the reference panel. When the two panels were machined on a router, the panel without the addition of glue showed more edge chipping and less clean milling than the test panel.

According to an example of an embodiment of the present invention for producing an OSB with a thickness of 19 mm, MUF glue (melamine urea formaldehyde glue) is used in the cover layer and PDMI glue in the middle layer. The ratio of cover layer to middle layer is approximately 30 to 70%.

First, glued cover layer strands are scattered on a conveyor belt. Using a strip of application devices (nozzle application), a polyethylene glycol (molecular weight: 200 g/mol) is sprayed onto the strand cake in quantities of 5 g/m². The middle layer is scattered on top. The nozzles are then used again to apply the same quantity of polyethylene glycol to the scattered middle layer. This is followed by the scattering of the second cover layer. The strand cake is subsequently pressed in a Contipress to form the OSB.

As a comparison, an OSB was produced using the same gluing system but without a polyglycol application. Once cooled, the panels were tested in a laboratory for transverse tensile strength. It was discovered that the reference sample did not tear in the middle; rather, it tore between the cover layer and the middle layer. The test values were also approximately 20% lower.

### BRIEF DESCRIPTION OF DRAWINGS

An embodiment of the present invention will now be described with the aid of figures. They show

FIG. 1 shows a perspective and schematic sectional view of a wood material panel that can be produced according to an embodiment of the production method according to the invention, and

FIG. 2 shows a schematic flowchart of the production method.

### DETAILED DESCRIPTION

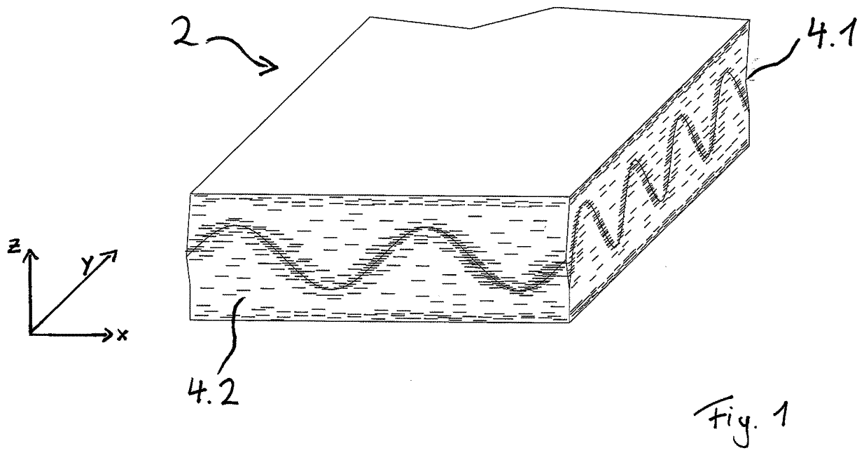

FIG. 1 is a perspective sectional view of a wood material panel 2 that can be produced according to an embodiment of the production method according to the invention. This type of wood material panel exhibits an expansion in the x, y and z directions. Here, the x direction relates to the expansion of the wood material panel transverse to the longitudinal direction y. The height or thickness of the wood material panel extends in the z direction.

In FIG. 1, areas 4.1 and 4.2 are depicted with different quantities of applied adhesive. Areas 4.1 are areas with a greater quantity of adhesive. Areas 4.2 are areas with a smaller quantity of adhesive.

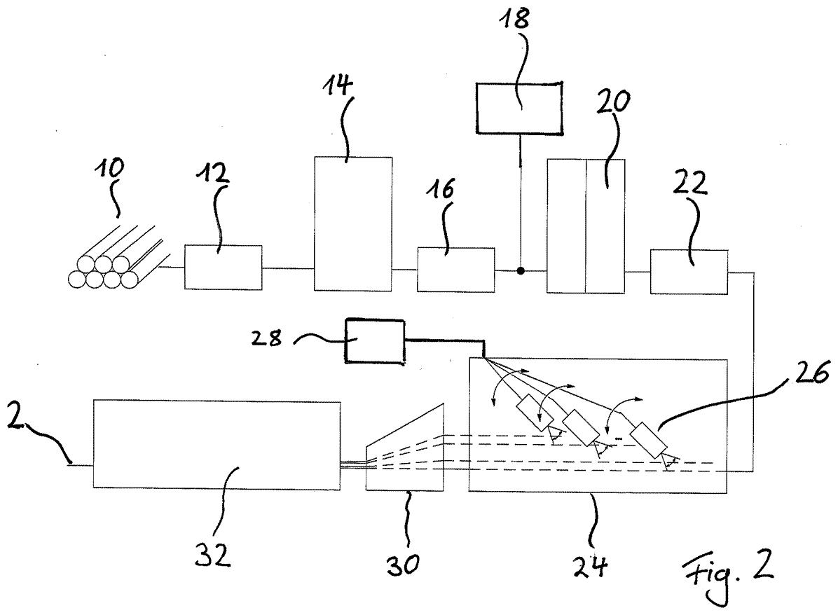

FIG. 2 schematically depicts the production process of a wood material panel; specifically, in this case, a wood fiber panel.

First, wood 10 is provided. Said wood is preferably forest wood or waste wood that has been de-barked beforehand. It is then processed in a comminution device 12, such as a disc chipper or a drum chipper, to produce wood chips. These wood chips are then fed into a boiler 14. Here, the wood chips are treated and cleaned under the influence of hot steam; if necessary, the wood chips may be pre-heated beforehand. For instance, the wood chips are macerated at a temperature of approximately 170° for around 3-4 minutes.

The maceration in the boiler 14 is followed by a fiber maceration of the wood chips in a refiner 16, especially in the case of wood fiber boards. In said refiner, the wood chips are ground, for example in a disc mill, a cylinder mill or a roller mill, and processed to produce wood fibers.

Subsequently, the—in particular still moist—wood fibers are pre-glued in a pre-gluing installation with an adhesive, such as urea formaldehyde resin (UF resin). The wood fibers are preferably separated either before or after this step so they are ready for the scattering heads later, which scatter said fibers in a scattering device 24 during a later step in the method. This has the advantage that the quantity of adhesive that is to be applied later by means of the glue nozzles, wherein said quantity may also be zero, can be adjusted especially easily depending on the anticipated position of the wood fibers.

The glued wood fibers are subsequently dried in a dryer 20, for instance using hot gas at a temperature of approximately 160°, for example, until a specific residual moisture level of, for example, 10-15% is reached.

The drying is followed by separation in a separator 22. Here, the fibers are separated according to, for instance, particle size or fiber length, mass or inertia. This is conducted, for example, in a gas flow in a so-called air separator.

Specifically, this renders it possible to remove any fiber sizes that are not suitable for further processing. In particular, fibers that are too large may be put through the comminution process again; fibers that are too small or pulverized wood particles may be removed from the rest of the process. Alternatively, it is also possible that the separation takes place before the wood fibers are glued.

Following separation, the wood fibers are fed into the scattering device 24, which specifically comprises a number, for example at least three, glue heads 26 with glue nozzles, not depicted. The scattering device 24 preferably comprises a conveyor belt, which can be moved in a transport direction. In particular, the glue nozzles of the glue heads 26 are arranged transversely to this transport direction. These glue nozzles preferably extend across the entire width of the conveyor belt, transverse to the transport direction. It is especially preferable if they can be swiveled in at least one, in particular in all, spatial directions.

The glue heads 26 are connected to an electrical control system 28 that is configured to adjust a quantity of adhesive to be applied to the wood particles depending on their position in the particulate cake, for example in a plane parallel to the longitudinal direction and the transverse direction.

Preferably, a continuous and constant quantity of wood particles is scattered through each glue head 26, wherein said quantity of wood particles may different between the individual glue heads 26. For instance, it is also possible that several glue nozzles of a glue head 26 which are arranged at a distance from one another transversely to the transport direction emit greater quantities of adhesive per time unit than other glue nozzles of this glue head 26.

The particulate cake produced by the scattering is pre-compacted in one or several pre-compacting steps in a pre-compacter 30. This may occur, for example, on a continuous basis or indeed an intermittent basis, i.e. in several separate steps.

The pre-compacter is followed by a hot press 32, by means of which the wood material panel 2 is formed from the pre-compacted particulate cake under the influence of heat and pressure. In the present case, this produces, for example, a large high-density fiberboard (HDF) panel or a mid-density fiberboard (MDF) panel.

Said panel may be produced by sawing the continuously formed wood material panel 2 in the transverse direction to the transport direction. These large panels are further processed to form a multitude of smaller panels, especially by sawing them in the transverse and/or longitudinal direction.

1. A method for producing a wood material panel, wherein the method comprises:
(a) scattering a multitude of wood particles to produce a particulate cake,
(b) applying an adhesive to at least some of the wood particles during the scattering and/or prior to the scattering, and
(c) pressing of the particulate cake under high pressure and at a high temperature, wherein a quantity of adhesive that is applied to the wood particles is varied depending on its anticipated position in the particulate cake.

2. The method according to claim 1, further comprising introducing at least one additive into the particulate cake during the scattering.

3. The method according to claim 2, wherein different quantities of the additive are introduced at different positions within the particulate cake.

4. The method according to claim 2, wherein the at least one additive is another adhesive or an adhesive component.

5. The method according to claim 2, wherein the at least one additive contains:
at least one filler, including chalk, talcum, quartz powder, glass beads, expanded glass or expanded clay,
at least one optical brightener, including titanium dioxide, calcium carbonate or fluorescent organic substances,
at least one flame retardant substance,
at least one biocidal substance,
at least one substance for preventing swelling of wood,
at least one foamer, and/or
at least one substance that alters a visual and/or haptic and/or physical property of the wood material panel.

6. The method according to claim 2, wherein different additives and/or different quantities of various additives are introduced at different positions within the particulate cake.

7. The method according to claim 2, wherein a quantity of wood particles, which are spread to form the particulate cake, varies depending on their anticipated position in the particulate cake.

8. A device for conducting a method according to claim 1, which comprises an electrical control system that is configured to vary a quantity of the adhesive that is to be applied to the wood particles depending on their anticipated position in the particulate cake.

9. The device according to claim 8, wherein the electrical control system has an electronic data processing device that is configured to access information saved in an electronic memory and, based on the information, to vary the quantity of the adhesive to be applied.

10. The device according to claim 8, wherein the device features at least one glue nozzle, by way of which the adhesive can be applied to the wood particles, wherein the electrical control system is configured to vary a quantity of the adhesive that can be applied by the at least one glue nozzle.

11. The device according to claim 10, wherein the at least one glue nozzle can be moved transversely to a transport direction of a conveyor belt onto which the wood particles are scattered.

12. The method according to claim 5, wherein the physical property of the wood material panel is thermal conductivity.
